(19) United States
(12) Patent Application Publication
(10) Pub. No.: US 2021/0268678 A1
(43) Pub. Date: Sep. 2, 2021

(54) METAL MEMBER MANUFACTURING METHOD

(71) Applicant: TOYOTA JIDOSHA KABUSHIKI KAISHA, Toyota-shi (JP)

(72) Inventors: Shunsuke TOBITA, Toyota-shi (JP); Tetsuji EGAWA, Okazaki-shi (JP); Masahide TATSUTOMI, Toyota-shi (JP)

(73) Assignee: TOYOTA JIDOSHA KABUSHIKI KAISHA, Toyota-shi (JP)

(21) Appl. No.: 17/162,132

(22) Filed: Jan. 29, 2021

(30) Foreign Application Priority Data
Feb. 28, 2020 (JP) 2020-033258

(51) Int. Cl. B26D 3/28

(52) U.S. Cl. CPC B26D 3/28

(57) ABSTRACT

A metal member manufacturing method according to one form of this disclosure is a method of manufacturing a metal member that is thinner at some portions than at other portions. The method includes: a formation step of pressing one surface of surfaces of a metal workpiece that are perpendicular to a thickness direction with a press-working die so as to form raised portions in the other surface; an application step of applying a lubricant; and a cutting step of moving a cutting blade along the other surface to cut off the raised portions by shaving. In the formation step, a sump in which the lubricant is held is formed between the raised portions in the other surface or at a position on a rear side of the raised portions in a moving direction of the cutting blade, and in the application step, the lubricant is applied to the sump.

### CROSS-REFERENCE TO RELATED APPLICATION

This application claims priority to Japanese Patent Application No. 2020-033258 filed on Feb. 28, 2020, incorporated herein by reference in its entirety.

### BACKGROUND

### 1. Technical Field

This disclosure relates to a metal member manufacturing method, and relates to, for example, a method of manufacturing a metal member that is thinner at some portions than at other portions.

### 2. Description of Related Art

In recent years, members used for vehicles and the like are required to be further reduced in weight from the viewpoint of energy conservation, and processing techniques for processing members so as to reduce the thickness at some portions for which the required strength is relatively lower than at other portions have been put to practical use.

For example, the metal member manufacturing method of Japanese Patent Application Publication No. 2019-5823 (JP 2019-5823 A) involves pressing one surface of surfaces of a metal workpiece that are perpendicular to a thickness direction with a press-working die so as to form a raised portion in the other surface, and then moving a cutting blade along the other surface to cut off the raised portion by shaving.

### SUMMARY

The present applicant found the following issue: In the metal member manufacturing method of JP 2019-5823 A, a lubricant applied to the cutting blade in advance leaves the cutting edge during shaving with the cutting blade, so that the cutting blade slides without a lubricant between the cutting blade and the metal workpiece, which shortens the life of the cutting blade.

This disclosure has been made in view of such an issue and provides a metal member manufacturing method that can shave a raised portion while avoiding shortening the life of a cutting blade.

A metal member manufacturing method according to one aspect of this disclosure is a method of manufacturing a metal member that is thinner at some portions than at other portions, the method including:

a formation step of pressing one surface of surfaces of a metal workpiece that are perpendicular to a thickness direction with a press-working die so as to form raised portions in the other surface;

an application step of applying a lubricant; and

a cutting step of moving a cutting blade along the other surface to cut off the raised portions by shaving,

wherein in the formation step, a sump in which the lubricant is held is formed between the raised portions in the other surface or at a position on a rear side of the raised portions in a moving direction of the cutting blade, and

wherein in the application step, the lubricant is applied to the sump.

Thus, the lubricant held in the sump can be applied to the cutting edge of the cutting blade, and a state where a lubricant is present between the cutting edge of the cutting blade and the metal workpiece can be maintained. As a result, it is possible to shave the raised portions while avoiding shortening the life of the cutting blade.

In the above metal member manufacturing method, the raised portions and the sump may be formed at the same time by press-working.

Thus, there is no need for a separate step for forming the sump, so that a decrease in the productivity of the metal member can be avoided.

In the cutting step of the above metal member manufacturing method, the lubricant held in the sump may be applied to a cutting edge of the cutting blade when the cutting blade reaches the sump.

In the above metal member manufacturing method, the sump may extend in a direction orthogonal to a moving direction of the cutting blade.

Thus, the lubricant can be applied to a wide area of the cutting edge of the cutting blade.

According to this disclosure, a metal member manufacturing method that can shave a raised portion while avoiding shortening the life of a cutting blade can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing a flow of a metal member manufacturing method of Embodiment 1.

FIG. 2 is a sectional view showing how raised portions and a sump are formed in a metal workpiece.

FIG. 3 is a perspective view showing how a lubricant is applied to the sump.

FIG. 4 is a perspective view showing how the raised portions are shaved.

FIG. 5 is a sectional view showing a state where a cutting edge of a cutting blade has reached a point just short of the sump while shaving the raised portions.

FIG. 6 is a sectional view showing a state where the cutting edge of the cutting blade has reached the sump while shaving the raised portions.

FIG. 7 is a sectional view showing a state where the cutting edge of the cutting blade has passed the sump while shaving the raised portions.

FIG. 8 is a perspective view showing a state upon completion of shaving.

FIG. 9 is a view illustrating preferable lengths of the raised portions in a Y-axis direction.

FIG. 10 is a view illustrating a preferable length in the Y-axis direction and a preferable depth in a Z-axis direction of the sump.

FIG. 11 is a sectional view showing how a different metal workpiece is cut by shaving.

### DETAILED DESCRIPTION OF EMBODIMENTS

Specific embodiments to which this disclosure is applied will be described in detail below with reference to the drawings. However, the disclosure is not limited to the following embodiments. To clarify the illustration, the following description and the drawings are simplified as necessary.

### Embodiment 1

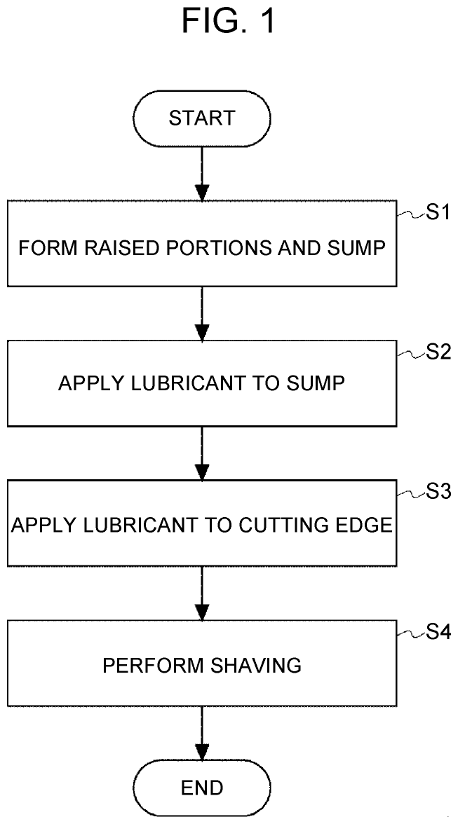

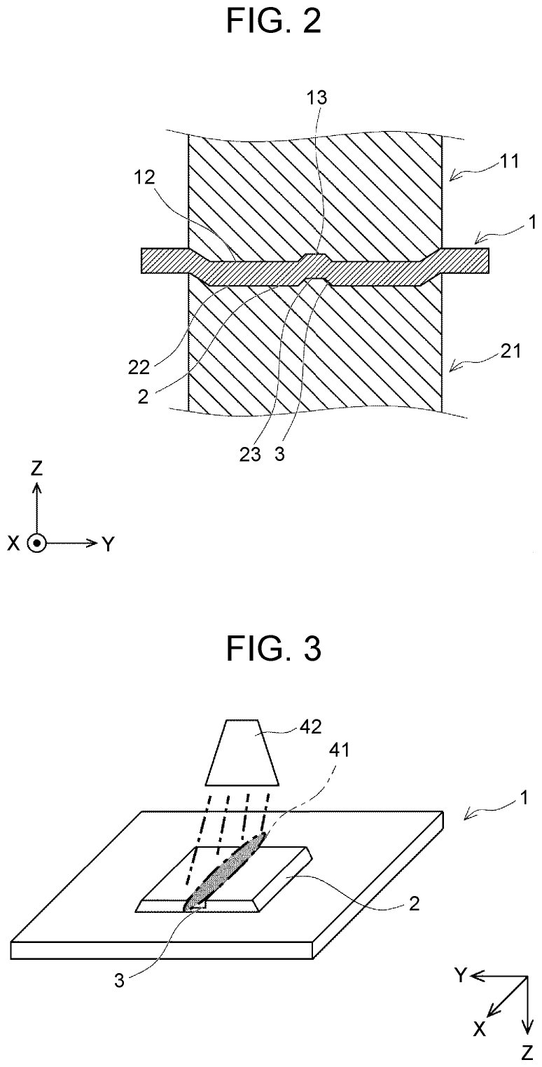

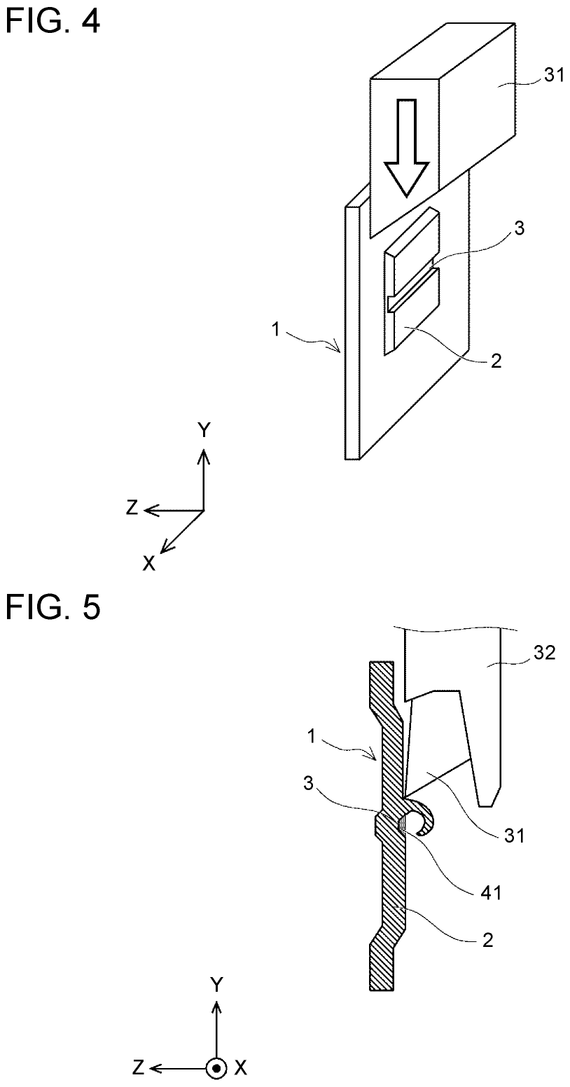

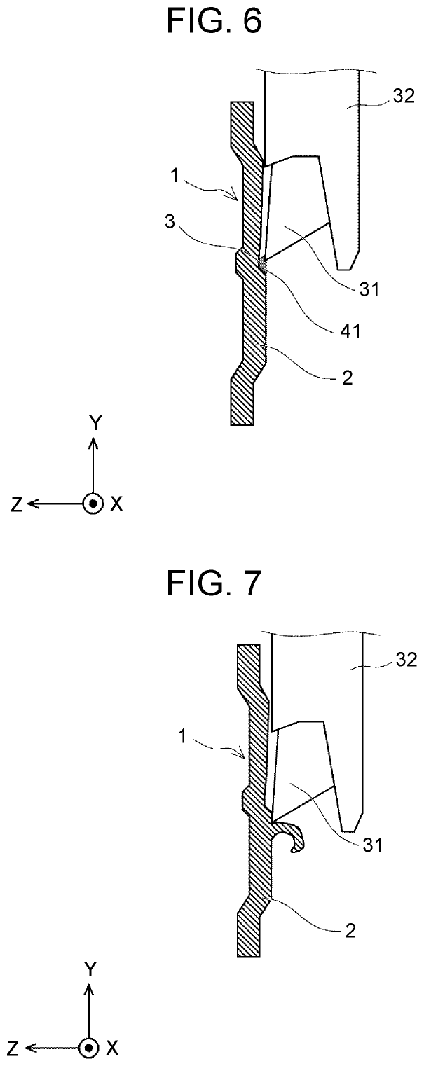

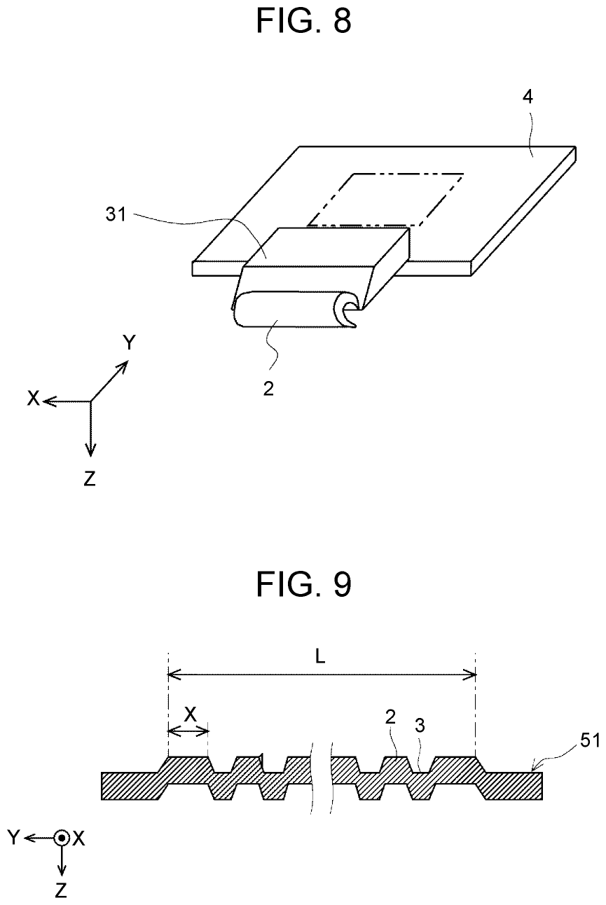

FIG. 1 is a flowchart showing a flow of a metal member manufacturing method of this embodiment. FIG. 2 is a sectional view showing how raised portions and a sump are formed in a metal workpiece. FIG. 3 is a perspective view showing how a lubricant is applied to the sump. FIG. 4 is a perspective view showing how the raised portions are shaved. FIG. 5 is a sectional view showing a state where a cutting edge of a cutting blade has reached a point just short of the sump while shaving the raised portions. FIG. 6 is a sectional view showing a state where the cutting edge of the cutting blade has reached the sump while shaving the raised portions. FIG. 7 is a sectional view showing a state where the cutting edge of the cutting blade has passed the sump while shaving the raised portions. FIG. 8 is a perspective view showing a state upon completion of shaving.

To clarify the illustration, a three-dimensional (XYZ) coordinate system is used in the following description. Here, a Z-axis direction is a thickness direction of the metal workpiece. In FIG. 4 etc., a lubricant applied to the cutting edge of the cutting blade in advance and others are omitted to simplify the drawings.

First, as shown in FIG. 2, a plurality of raised portions 2 and a sump 3 are formed in a plate-shaped metal workpiece 1 (S1). Specifically, the metal workpiece 1 has a surface on a Z-axis plus side and a surface on a Z-axis minus side that are substantially parallel to an XY-plane, and the metal workpiece 1 is sandwiched at a desired position between a first press-working die 11 and a second press-working die 21 from the Z-axis direction.

For example, the first press-working die 11 includes protrusions 12 that protrude toward the Z-axis minus side to form the raised portions 2 at an interval in a Y-axis direction, and a groove 13 that is disposed between the protrusions 12 and extends in an X-axis direction while being depressed toward the Z-axis plus side. The numbers of the protrusions 12 and the grooves 13 can be changed as necessary according to the numbers of the raised portions 2 and the sumps 3 to be formed in the metal workpiece 1.

For example, the second press-working die 21 has a shape corresponding to that of the first press-working die 11, and includes recesses 22 that house portions of the metal workpiece 1 pressed by the protrusions 12 of the first press-working die 11, and a protrusion 23 that is disposed between the recesses 22 and extends in the X-axis direction while protruding toward the Z-axis plus side to form the sump 3 between the raised portions 2. The numbers of the recesses 22 and the protrusions 23 can be changed as necessary according to the numbers of the raised portions 2 and the sumps 3 to be formed in the metal workpiece 1.

The first press-working die 11 and the second press-working die 21 are disposed such that the protrusions 12 and the groove 13 of the first press-working die 11 and the recesses 22 and the protrusion 23 of the second press-working die 21 face each other in the Z-axis direction, and at least one of the first press-working die 11 and the second press-working die 21 can move in the Z-axis direction.

Thus, for example, two raised portions 2 protruding toward the Z-axis minus side, and the sump 3 that is disposed between the raised portions 2 and extends in the X-axis direction while being depressed toward the Z-axis plus side are formed in the metal workpiece 1.

Here, as will be described in detail later, the sump 3 is preferably disposed such that a lubricant 41 (see FIG. 3) on a cutting edge of a cutting blade 31 (see FIG. 4) is not lost before one raised portion 2 has been cut off by the cutting blade 31. The sump 3 is preferably formed so as to extend from an end of the raised portion 2 on an X-axis plus side to an end thereof on an X-axis minus side.

Next, as shown in FIG. 3, the lubricant 41 is applied to the sump 3 (S2). Specifically, the metal workpiece 1 is disposed with the surface on the Z-axis minus side facing the opposite direction from the direction of the gravitational force (i.e., facing upward), and the lubricant 41 is applied to the sump 3 by an applicator 42 from the Z-axis minus side. Then, the lubricant 41 is applied to the cutting edge of the cutting blade 31 (S3). Steps S2 and S3 may be performed in a reverse order or concurrently.

Next, as shown in FIG. 4, the cutting blade 31 is moved toward a Y-axis minus side along the surface of the metal workpiece 1 on the Z-axis minus side to cut off the raised portions 2 by shaving (S4). Here, as shown in FIG. 5 etc., the cutting blade 31 can move in the Y-axis direction in a state of being mounted on a holder 32. The cutting edge of the cutting blade 31 is substantially parallel to the XY-plane and extends in the X-axis direction.

As the cutting blade 31 thus moves toward the Y-axis minus side and cuts off the raised portion 2 disposed on a Y-axis plus side, the lubricant 41 on the cutting edge of the cutting blade 31 decreases. As shown in FIG. 6, when the cutting blade 31 moves further toward the Y-axis minus side and finishes cutting off the raised portion 2 disposed on the Y-axis plus side and the cutting edge of the cutting blade 31 reaches the sump 3, the lubricant 41 held in the sump 3 is applied to the cutting edge of the cutting blade 31.

Then, with the lubricant 41 applied to the cutting edge of the cutting blade 31, as shown in FIG. 7, the raised portion 2 disposed on the Y-axis minus side starts to be shaved. As shown in FIG. 8, when the cutting edge of the cutting blade 31 reaches the end on the Y-axis minus side of the raised portion 2 disposed on the Y-axis minus side, a metal member 4 with the raised portions 2 cut off can be manufactured.

Thus, in the manufacturing method of the metal member 4 of this embodiment, the sump 3 is disposed between the raised portions 2, so that the lubricant 41 on the cutting edge of the cutting blade 31 is unlikely to be lost in the middle of cutting off the raised portions 2 by shaving. Therefore, a state where the lubricant 41 is present between the cutting edge of the cutting blade 31 and the metal workpiece 1 can be maintained, and as a result, it is possible to shave the raised portions 2 while avoiding shortening the life of the cutting blade 31.

Moreover, in the manufacturing method of the metal member 4 of this embodiment, the raised portions 2 and the sump 3 can be formed at the same time when the metal workpiece 1 is sandwiched between the first press-working die 11 and the second press-working die 21. Thus, there is no need for a separate step for forming the sump 3, so that a decrease in the productivity of the metal member 4 can be avoided.

Further, in the manufacturing method of the metal member 4 of this embodiment, the lubricant 41 can be applied to the sump 3 as a continuation of applying the lubricant 41 to the cutting edge of the cutting blade 31. Thus, there is no need for a separate step for applying the lubricant 41 to the sump 3, so that, again, a decrease in the productivity of the metal member 4 can be avoided.

In addition, in this embodiment, the sump 3 extends in the X-axis direction substantially orthogonal to the Y-axis direction that is the moving direction of the cutting blade 31, so that the lubricant can be applied to a wide area of the cutting edge of the cutting blade 31.

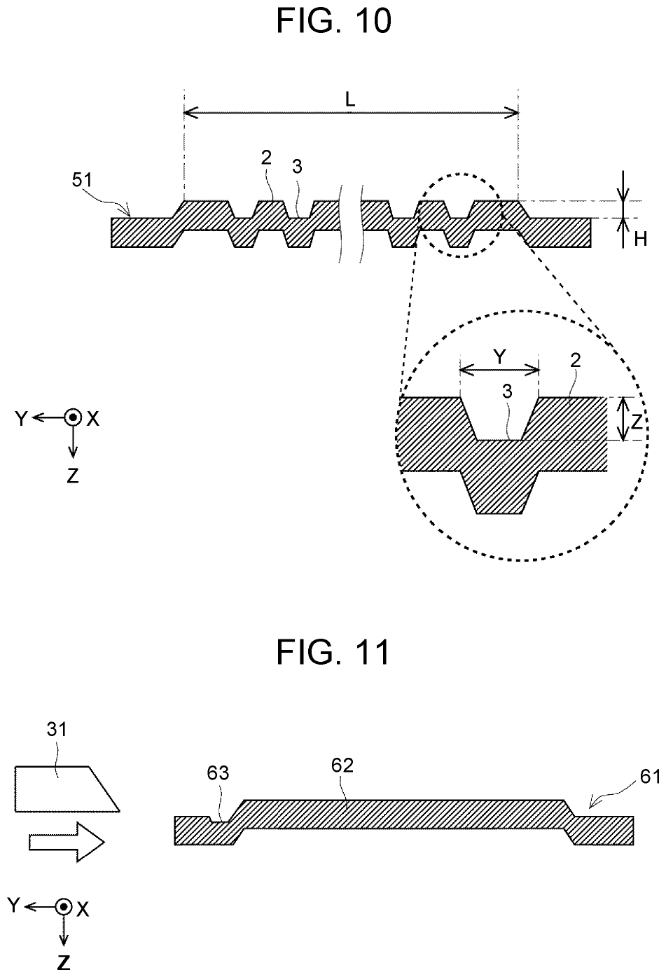

Next, preferable shapes of the raised portions 2 and the sump 3 of this embodiment will be described. FIG. 9 is a view illustrating preferable lengths in the Y-axis direction of the raised portions of the embodiment. FIG. 10 is a view illustrating a preferable length in the Y-axis direction and a preferable depth in the Z-axis direction of the sump of the embodiment. FIG. 9 and FIG. 10 schematically show a metal workpiece 51 in which the raised portions 2 and the sumps 3 are formed, and the metal workpiece 51 is different from the metal workpiece 1 shown in FIG. 1 etc. in the numbers of the raised portions 2 and the sumps 3 and other respects.

It is preferable that the length of the raised portion 2 in the Y-axis direction meet the following Formula 1. Here, as shown in FIG. 9, X is the length of the raised portion 2 in the Y-axis direction (i.e., the length of the raised portion 2 from an end point on the Y-axis plus side to an end point on the Y-axis minus side, both in a surface on the Z-axis minus side), and L is a shaving length along which the raised portions 2 are shaved by a pressing machine, and is a length from an end point on the Y-axis minus side of the raised portion 2 disposed farthest on the Y-axis minus side to an end point on the Y-axis plus side of the raised portion 2 disposed farthest on the Y-axis plus side (i.e., a length from the end point on the Y-axis minus side, in a surface on the Z-axis minus side, of the raised portion 2 disposed farthest on the Y-axis minus side to the end point on the Y-axis plus side, in a surface on the Z-axis minus side, of the raised portion 2 disposed farthest on the Y-axis plus side).

L/20<X<L Formula 1:

For example, if L is assumed to be 300 mm that is a maximum length, the weight reducing effect on the metal member is reduced when X is equal to or smaller than L/20.

It is preferable that the length of the sump 3 in the Y-axis direction meet the following Formula 2. Here, as shown in FIG. 10, Y is the length of the sump 3 in the Y-axis direction (i.e., the length of the sump 3 from an end point on the Y-axis minus side to an end point on the Y-axis plus side, both on the Z-axis minus side).

L/100<Y<L/2 Formula 2:

For example, if L is assumed to be 300 mm that is the maximum length, when Y is equal to or smaller than L/100, it is difficult to form the sump 3 in the metal workpiece 51. If L is assumed to be 30 mm that is a minimum length, when Y is equal to or larger than L/2, the lubricant 41 cannot be held in the sump 3.

It is preferable that the depth of the sump 3 in the Z-axis direction meet the following Formula 3. Here, as shown in FIG. 10, Z is the depth of the sump 3 in the Z-axis direction and H is the height of the raised portion 2 in the Z-axis direction.

H/10<Z<H Formula 3:

For example, if H is assumed to be 5 mm, when Z is equal to or smaller than H/10, the depth of the sump 3 is not large enough to hold the lubricant 41 in the sump 3.

### Embodiment 2

FIG. 11 is a sectional view showing how a metal workpiece is cut by shaving in a metal member manufacturing method of this embodiment. In FIG. 11, a lubricant applied to the cutting edge of the cutting blade and others are omitted to simplify the drawing. Here, a flow of the metal member manufacturing method of this embodiment is substantially the same as that of the manufacturing method of the metal member 4 of Embodiment 1, and therefore an overlapping description will be omitted and the same members will be denoted by the same reference signs.

In the metal member manufacturing method of this embodiment, one raised portion 62 is formed in a metal workpiece 61, and a sump 63 is formed at a position on a rear side of the raised portion 62 in a moving direction of the cutting blade 31 (i.e., a position on the Y-axis plus side relative to the raised portion 62).

Thus, the lubricant 41 is sufficiently applied to the cutting edge of the cutting blade 31 by the sump 63 before the raised portion 62 starts to be shaved. Therefore, the lubricant 41 can be sufficiently applied to the cutting edge of the cutting blade 31 before the raised portion 62 is cut off by the cutting blade 31, so that the lubricant 41 on the cutting edge of the cutting blade 31 is unlikely to be lost in the middle of cutting off the raised portion 62 by shaving.

While one raised portion 62 is formed and the sump 63 is formed in this embodiment, a plurality of raised portions may be formed and a sump between the raised portions and a sump on the Y-axis plus side relative to the raised portions may be formed. In this case, the raised portions, the sump between the raised portions, and the sump on the Y-axis plus side relative to the raised portions are preferably formed at the same time by press-working.

This disclosure is not limited to the above embodiments but can be changed as necessary within the scope of the gist thereof.

What is claimed is:

1. A method of manufacturing a metal member that is thinner at some portions than at other portions, the method comprising:
a formation step of pressing one surface of surfaces of a metal workpiece that are perpendicular to a thickness direction with a press-working die so as to form raised portions in the other surface;
an application step of applying a lubricant; and
a cutting step of moving a cutting blade along the other surface to cut off the raised portions by shaving,
wherein in the formation step, a sump in which the lubricant is held is formed between the raised portions in the other surface or at a position on a rear side of the raised portions in a moving direction of the cutting blade, and
wherein in the application step, the lubricant is applied to the sump.

2. The metal member manufacturing method according to claim 1, wherein the raised portions and the sump are formed at the same time by press-working.

3. The metal member manufacturing method according to claim 1, wherein in the cutting step, the lubricant held in the sump is applied to a cutting edge of the cutting blade when the cutting blade reaches the sump.

4. The metal member manufacturing method according to claim 1, wherein the sump extends in a direction orthogonal to a moving direction of the cutting blade.
